(19) United States
(12) Patent Application Publication
(10) Pub. No.: US 2012/0085333 A1
(43) Pub. Date: Apr. 12, 2012

(54) APPARATUS AND METHOD FOR SAWING SINGLE CRYSTAL INGOT

(76) Inventors: Ki-Soo Kwon, Chilgok-gun (KR); Heui-Don Cho, Gumi-si (KR); Dong-Ouk Ji, Buk-gu (KR)

(21) Appl. No.: 13/272,161

(22) Filed: Oct. 12, 2011

(30) Foreign Application Priority Data
Oct. 12, 2010 (KR) 10-2010-0099111

(51) Int. Cl. B28D 1/08; B28D 5/00

(52) U.S. Cl. 125/21

(57) ABSTRACT

Provided are an apparatus and a method for sawing a single crystal ingot. The apparatus includes a wire saw sawing an ingot, a roller driving the wire saw, and a bath containing a liquid cooling the ingot before sawing the ingot.

### CROSS-REFERENCE TO RELATED APPLICATIONS

The present application claims the benefit of priority under 35 U.S.C. 119 to Korean Patent Application No. 10-2010-0099111 filed Oct. 12, 2011 which is hereby incorporated by reference in its entirety.

### BACKGROUND OF THE INVENTION

1. Background of the Invention

Embodiments relate to an apparatus and a method for sawing a single crystal ingot.

2. Description of the Related Art

In general, a process of manufacturing a wafer for a semiconductor device includes: a process of slicing a silicon ingot; an edge grinding process for rounding an edge of a wafer formed by slicing the silicon ingot; a lapping process for planarizing a rough surface of the wafer due to the slicing; a cleaning process for removing various impurities particles, generated during the edge grinding process or the lapping process, from the wafer; a surface grinding process for the wafer to have a shape and a surface quality adapted for a process to be performed later; and a process of grinding an edge of the wafer.

For example, in the process of slicing a silicon ingot, a single crystal ingot placed on a table is sawed in the form of a wafer with a predetermined sawing apparatus such as a wire saw while the single crystal ingot is moved in top-down direction and is supplied with slurry.

Heat generated when sawing a single crystal ingot, and a difference between the heat and total heat may cause expansion and contraction of the single crystal ingot and a main roller. Thus, a cut surface of the single crystal ingot may be uneven, which cause a defect such as a warp and nanotopography degradation.

### SUMMARY

Embodiments provide an apparatus and a method for sawing a single crystal ingot, which minimize heat generated while sawing an object.

In one embodiment, a single crystal ingot sawing apparatus includes: a wire saw sawing an ingot; a roller driving the wire saw; and a bath containing a liquid cooling the ingot before sawing the ingot.

In another embodiment, a single crystal ingot sawing method includes: immersing an ingot in a bath containing a predetermined liquid, before sawing the ingot; supplying the ingot in down-up direction from the bath to a wire saw; and sawing the ingot.

The details of one or more embodiments are set forth in the accompanying drawings and the description below. Other features will be apparent from the description and drawings, and from the claims.

### BRIEF DESCRIPTION OF THE DRAWINGS

FIG. 1 is a front view illustrating a single crystal ingot sawing apparatus according to an embodiment.

FIG. 2 is a side view illustrating a single crystal ingot sawing apparatus according to an embodiment.

### DETAILED DESCRIPTION

Reference will now be made in detail to the preferred embodiments of the present disclosure, examples of which are illustrated in the accompanying drawings.

In the description of embodiments, it will be understood that when a wafer, device, chuck, member, part, region, or surface is referred to as being ‘on’ or ‘under’ another wafer, device, chuck, member, part, region, or surface, the terminology of ‘on’ and ‘under’ includes both the meanings of ‘directly’ and ‘indirectly’. Further, the reference about ‘on’ and ‘under’ each component will be made on the basis of drawings. In addition, the sizes of elements and the relative sizes between elements may be exaggerated for further understanding of the present disclosure.

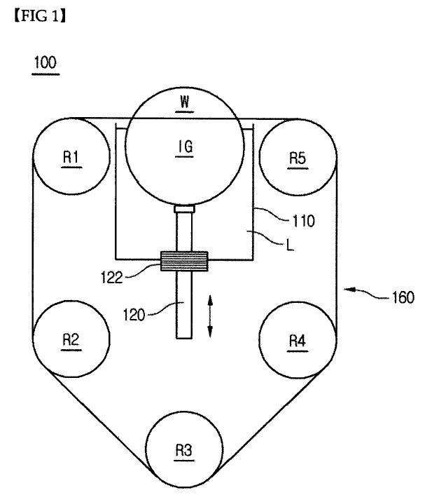

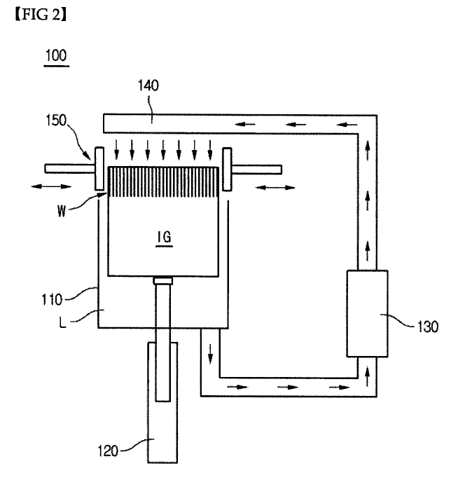

FIG. 1 is a front view illustrating a single crystal ingot sawing apparatus according to an embodiment. FIG. 2 is a side view illustrating a single crystal ingot sawing apparatus according to an embodiment.

A method of manufacturing a single crystal ingot is as follows. A Czochralski (CZ) method or a float zone (FZ) method is used to form a bar-shaped single crystal body from poly-crystal silicon, then, the surface of the bar-shaped single crystal body is treated to have a constant diameter, and then, the bar-shaped single crystal body is sawed to have a constant length.

For example, in the CZ method, seed is immersed in a melt solution including poly-crystal silicon, then, a seed crystal is grown at high speed, and then, a necking process is performed. At this point, a single crystal is gradually grown in a radial direction with the seed, and a shouldering process is performed when the single crystal has a predetermined diameter. After that, a body is grown to have a predetermined length, and then, a tailing process is performed to decrease the diameter of the body and remove the body from the melt solution, thereby forming a single crystal ingot.

Thereafter, a cropping process is performed to cut a body of the single crystal ingot to have a predetermined size, and then, an outer surface of the body, which has a bar shape, is ground to have a predetermined diameter.

After that, the body of the single crystal ingot is moved on a table, and is supplied with slurry. In this state, the body of the single crystal ingot is sawed in the form of a wafer with a predetermined sawing apparatus such as a wire saw.

In this case, the slurry may be excessively supplied, and the single crystal ingot may be thermally expanded during the sawing. In addition, since a wire guide shaft of the sawing apparatus may be extended, a profile of a cut surface of a wafer may be uneven.

Thus, in the related art, an uneven profile of a cut surface of a wafer causes a defect such as a waviness pattern in nanotopography maps.

Embodiments provide an apparatus and a method for sawing a single crystal ingot, which minimize heat generated while sawing an object.

Hereinafter, an apparatus and a method for sawing a single crystal ingot according to an embodiment will be described with reference to FIGS. 1 and 2.

According to the current embodiment, an ingot sawing apparatus 100 may include: a wire saw 160 sawing an ingot IG; a plurality of rollers R1, R2, R3, R4, and R5 driving the wire saw 160; and a bath 110 accommodating a liquid L for cooling the ingot IG before sawing the ingot IG.

Although the rollers R1, R2, R3, R4, and R5 are provided in the current embodiment, the number of rollers is not limited thereto.

The ingot sawing apparatus 100 may be a bath-type ingot sawing apparatus to prevent heat, generated during sawing of an object, from being transferred to the object, thereby preventing expansion and contraction of the object.

Since the ingot IG contacts the liquid L before being sawed, the ingot IG is maintained at a constant temperature in the bath 110, and is exposed to an atmospheric condition when being sawed.

To this end, the ingot sawing apparatus 100 may include a moving device 120 to move the ingot IG upward from the bath 110.

For example, the moving device 120 may move the ingot IG in down-up direction from the bath 110 to the wire saw 160, but is not limited thereto. The moving device 120 may be a hydraulic cylinder, but is not limited thereto.

The ingot sawing apparatus 100 may include a leak prevention O-ring 122 between the moving device 120 and the bath 110.

Accordingly, since the ingot IG contacts the liquid L before being sawed, expansion and contraction of the ingot IG due to heat generated during the sawing can be minimized.

According to the embodiment, before being sawed, an object is placed in a slurry bath at a constant temperature, and thus, expansion and contraction of the object due to heat generated during the sawing can be minimized.

The liquid L may include slurry, but is not limited thereto.

The ingot sawing apparatus 100 may include a heat exchanger 130 to maintain the liquid L in the bath 110 at a set temperature.

Further, the ingot sawing apparatus 100 may include a slurry nozzle 140 for supplying slurry to the wire saw 160.

Accordingly, the liquid L can circulate sequentially through the bath 110, the heat exchanger 130, the slurry nozzle 140, the wire saw 160, and the bath 110, but is not limited thereto.

The ingot sawing apparatus 100 may include a variable guide 150 that supports wafers W formed by sawing the ingot IG.

The variable guide 150 can move left and right to prevent the wafers W from going away from one another during the cutting of the ingot IG.

According to the embodiment, before being sawed, an object is placed in a slurry bath at a constant temperature, and thus, expansion and contraction of the object due to heat generated during the sawing can be minimized.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A single crystal ingot sawing apparatus, the apparatus comprising:
a wire saw that saws an ingot;
a roller driving the wire saw; and
a bath containing a liquid that cools the ingot before sawing the ingot.

2. The single crystal ingot sawing apparatus of claim 1, further comprising a moving device that moves the ingot upward.

3. The single crystal ingot sawing apparatus of claim 1, wherein the ingot contacts the liquid before the ingot is sawed.

4. The single crystal ingot sawing apparatus of claim 1, wherein the liquid comprises slurry.

5. The single crystal ingot sawing apparatus of claim 1, further comprising a heat exchanger that maintains the liquid in the bath at a certain temperature.

6. The single crystal ingot sawing apparatus of claim 5, further comprising a slurry nozzle for supplying slurry to the wire saw, wherein the liquid is supplied from the bath to the wire saw sequentially through the heat exchanger and the slurry nozzle.

7. The single crystal ingot sawing apparatus of claim 1, further comprising a variable guide that supports a wafer according to the sawing of the ingot.

8. A single crystal ingot sawing method, the method comprising:
immersing an ingot in a bath containing a predetermined liquid before sawing the ingot;
supplying the ingot in down-up direction from the bath to a wire saw; and
sawing the ingot.

9. The single crystal ingot sawing method of claim 8, wherein the ingot contacts the liquid before the ingot is sawed.

10. The single crystal ingot sawing method of claim 8, wherein the liquid is supplied from the bath to the wire saw sequentially through a heat exchanger and a slurry nozzle.
